(19) United States
(12) Patent Application Publication
(10) Pub. No.: US 2010/0091782 A1
(43) Pub. Date: Apr. 15, 2010

(54) Method and System for Controlling a Delay of Packet Processing Using Loop Paths

(75) Inventor: James S. Hiscock, Rockport, MA (US)

Correspondence Address: 3COM CORPORATION, 350 CAMPUS DRIVE, MARLBOROUGH, MA, 01752-3064, US

(73) Assignee: 3Com Corporation, Marlborough, MA (US)

(21) Appl. No.: 12/249,244

(22) Filed: Oct. 10, 2008

(51) Int. Cl. H04L 12/56

(52) U.S. Cl. 370/412

(57) ABSTRACT

A method and system for introducing controlled delay of packet processing at a network device using one or more delay loop paths (DLPs). For each packet received at the network device, a determination will be made as to whether or not packet processing should be delayed. If delay is chosen, a DLP will be selected according to a desired delay for the packet. The desired delay value is used to determine a time value and inserts the time value in the DLP ahead of the packet. Upon completion of a DLP delay, a packet will be returned for processing, an additional delay, or some other action. One or more DLPs may be enabled with packet queues, and may be used advantageously by devices, for which in-order processing of packets may be desired or required.

### FIELD OF THE INVENTION

The present invention relates to packet processing in a packet-switched network. In particular, the present invention is directed to a method and system for controlling a delay of packet processing using one or more delay loop paths.

### BACKGROUND OF THE INVENTION

Packet-switch networks, such as the Internet, transport data between communicating devices using packets that are routed and switched across one or more links in a connection path. As packet-switched networks have grown in size and complexity, their role in the critical functioning of businesses, institutions, and organizations has increased dramatically.

Many types of packet processing devices have been designed to assist in getting business critical data from a source to destination in a timely and secure manner. In-line data inspection devices such as Intrusion Detection and Intrusion Prevention Systems (IDS & IPS) inspect traffic carried by the packets. Other devices connected at the edge of a network, transport network traffic across the network to one or more other network edge devices. Such network traffic may be transported using tunneling protocols, encapsulated packets, and may be encrypted to get the packets to the destination in a timely and secure manner.

Packet processing devices can be implemented as an in-line hardware and/or software based device that can perform deep packet inspection (DPI), examining the content encapsulated in a packet header or payload, regardless of protocol or application type and tracks the state of packet streams between network attached systems. Thus, in addition to routing and switching operations that networks carry out as they route and forward packets between sources and destinations, packet processing devices can introduce significant packet processing actions that are performed on packets as they travel from source to destination. Other network security methods and devices may similarly act on individual packets, packet streams, and other packet connections.

The performance of a system that utilizes the network services can vary based on how the traffic is delivered. For example, packets that carry the network traffic may not arrive at the destination in the same order as they where sent, the end node may have to reorder the data if the network does not provide an in-order data delivery service. The performance of the end node, and hence the whole system, may decrease if the end node has to reorder the data. If the network can provide an in-order data deliver service that reorders the delivered data, the whole system performance may increase.

### SUMMARY OF THE INVENTION

As packets in a given communication or connection are routed from source to destination, an initial order in which the packets were transmitted from a source device may become altered, so that one or more packets arrive out of sequence with respect to the initial transmission order. For instance, packets from the same communication could be routed on different links with different traffic properties, causing delayed arrival of an earlier-sequenced packet relative to a later-sequenced packet. Further, one or more intermediate routers or switches may fragment packets, and the fragments themselves could arrive out of order. As they are transported to their destination out-of-sequence packets may also traverse intermediate network elements and components as well, including IPS devices or other packets processing devices. Some network technologies provide packet retransmit function to replace packets that were lost due to transmission error or lack of storage. Packets may be delivered out of order due one or more packets being lost and then later being retransmitted. Knowing the time between the packet being lost and the packet being retransmitted will help determine how long to wait for a lost packet to be able to place it back in order with the other packets carrying the data sent from a source to a destination.

Depending upon the specific packet-processing functions carried out, out-of-sequence receipt of packets may impact the operation an IPS, other packet processing devices, or the end nodes destined to receive the network traffic. In particular, processing of an out-of-sequence packet may need to be delayed until the in-sequence counterpart arrives. Further, it may be desirable to be able to tune the delay of a particular packet based on such factors as packet type, communication type, or known traffic characteristics, to name just a few. Therefore, a device such as an IPS or other packet processing devices may benefit by having an ability to introduce controlled delay of packet processing of packets received from the network or from internal processing components.

Accordingly, the present invention is directed to a method and system for introducing controlled delay of packet processing. More particularly, a method and system is described for introducing controlled delay of packet processing by a packet processing platform using one or more delay loop paths. The embodiments described herein exemplify controlled delay of packet processing by a security device such as an IPS, but it should be understood that the method and system applies to any packet processing device such as a VPN server, Ethernet switch or router, intelligent network interface (NIC), or a firewall. Further, while out-of-sequence receipt of packets has been described as a reason for imposing controlled delay, other reasons are possible as well, such as spreading traffic out, that may not have been reordered, but may have bunched together and now presents a traffic burst. The present invention is not limited to controlled delay for out-of-sequence packets or to pace network traffic, but instead covers any reason for delaying the processing of a packet.

In one respect, the invention is directed to a method and system for introducing controlled delay in the processing of packets in a packet-switched data network, including determining that a packet should be delayed, selecting a delay loop path (DLP) according to a desired delay for the packet, and sending the packet to the selected DLP. The determination that a delay is need, as well as the selection of DLP according to the desired delay, can be based on a property of the packet, the communication protocol indicated by one or more fields in the packet, and whether the network provides packet retransmission. In particular, recognizing that a packet has been received out of order with respect to at least one other packet in a communication or connection, understanding the protocol used by communication, and retransmission parameters implemented by the protocol of the network interconnection devices, may be used to determine both that a delay is required, and what the delay should be. As noted, however, there may be other properties of a packet that necessitate controlled delay of processing.

The construction of the DLP will determine if packets can be inserted between other packets already in the DLP or if packets can only be added at the end of the DLP. If the DLP can accept new packets being adding between packets already on the DLP, then only one, or a small number of DLPs can be used. On the other hand, if the DLP can only accept new packets added to the end of the DLP, then the newly added packet can only be delayed longer than all the other packets on a single DLP and, therefore, multiple DLPs are needed.

Note that packets may be received at the network entity from an end node, or component in the network, such a VPN server, router, or a switch. Alternatively or additionally, packets may be received from one or more DLPs once they complete their delays. That is, once a controlled delay for a given packet is complete, the packet is returned for processing. Upon return following controlled delay, a packet may either be processed or subjected to another delay. For example, following delay, an out-of-sequence packet may be processed if its in-sequence counterpart has arrived in the meantime. If not, it may be sent for a new possibly shorter last chance delay, forwarded without processing, or discarded. Other actions are possible as well.

In still a further respect, the present invention is directed to a system for introducing controlled delay in the processing of packets in a packet-switched network, the system comprising a processor, a network interface, one or more delay loop paths (DLPs), data storage, and machine language instructions stored in the data storage and executable by the processor to carry out the functions described above (and detailed further below). Specifically, the functions carried out by the processor according to the machine language instructions preferably comprise receiving a packet at the network interface, determining that the packet needs to be delayed before processing, selecting a delay loop path according to its path delay (as described above), and sending the packet to the selected DLP. Additionally, the system may receive a packet from a DLP. The machine language instructions will preferably also be executable to determine to delay the packet again, forward the packet or discard the packet.

In further accordance with a preferred embodiment, the processor, the network interface, one of more DLPs, and the data storage will each be a component of a field-programmable gate array (FPGA). Further, each of the processor, the network interface, the one or more DLPs, and the data storage will preferably comprise one or more sub-elements of the FPGA. That is, each of the specified system components will be implemented on an FPGA, and may in turn be composed, at least in part, of one or more low-level FPGA elements.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible. For instance, structural elements and process steps can be rearranged, combined, distributed, eliminated, or otherwise changed, while remaining within the scope of the invention as claimed.

### BRIEF DESCRIPTION OF THE DRAWINGS

FIG. 1 is a block diagram of out-of-sequence arrival of packet fragments at a packet processing platform;

FIG. 2 is a block diagram of controlled delay of packet processing using a single delay loop path with time information according to the invention;

FIG. 3 is a flowchart that illustrates exemplary operation of controlled delay of packet processing using one or more delay loop paths with time information and adding a packet to a DLP according to the invention;

FIG. 4 is a flowchart of an exemplary operation of controlled delay of packet processing using one or more delay loop paths with time information and removing a packet from a DLP according to the invention;

FIG. 5 is a block diagram of controlled delay of packet processing using multiple delay loop paths with time information according to the invention.

### DETAILED DESCRIPTION

The method and system described herein is based largely on introducing controlled delay of packets using a construct called a delay loop path (DLP). More particular, in order to impose a range of delay times to accommodate a possibly large number of packets and a variety of packet types and delay conditions, a single DLP with the ability to insert packets in an ordered list, or multiple delay loop paths can be employed. Packets that are determined to have arrived to a packet processing platform out of sequence may then be subject to a controlled delay appropriate to the properties of the individual packets. Packet processing platforms that can use the invention include IPS devices, virtual private network (VPN) servers, Ethernet switches, intelligent network adapters (NICs), or routers, firewalls, any network interconnect device connecting components of a LAN, or connecting a LAN to a public WAN. Additionally, other criteria, such as network conditions or routes, traffic pacing, protocols used, or network device retransmissions, may be considered as well in determining the need for and the length of delay. For further description of delay loop paths, see, e.g., U.S. patent application Ser. No. 11/745,307, titled “Method and System for Controlled Delay of Packet Processing with Multiple Loop Paths,” filed on May 7, 2007 by Smith, et al.

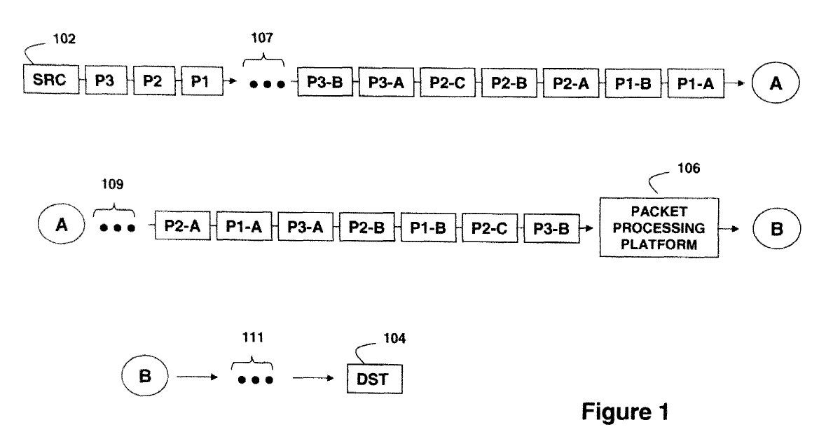

To facilitate the discussion of controlled delay using one or more DLPs, it is useful to first consider a simplified example of network packet transmission that yields out-of-sequence arrival of packets and packet fragments at a packet processing platform. Such a scenario is depicted in FIG. 1. As shown, SRC 102 transmits packet sequence {P1, P2, P3} to DST 104 by way of packet processing platform 106. Note that this packet sequence may represent only a subset of packets associated with a given transmission. For the purposes of the present description, the details of the network or networks between SRC 102, DST 104, and packet processing platform 106 are not critical and are represented simply as ellipses 107, 109, and 111. Note also that the transmission path is depicted in three segments (top, middle, and bottom) for illustrative purposes, and that the two circles each labeled “A” simply indicate continuity of the figure between the top and middle two segments and the two circles each labeled “B” indicate continuity of the figure between the middle and bottom segments.

In the exemplary transmission, each packet is fragmented into smaller packets at some point within the network elements represented by ellipses 107, for example at one or more packet routers. The exemplary fragmentation results in packet P1 being subdivided into two packets, designated P1-A and P1-B. Packet P2 is subdivided into three packets, P2-A, P2-B, and P2-C, while packet P3 is subdivided into two packets P3-A and P3-B. As indicated, all of the initial fragments are transmitted in order as sequence {P1-A, P1-B, P2-A, P2-B, P2-C, P3-A, P3-B }. During traversal of the network elements represented by ellipses 109, the order of transmission of the packet fragments becomes altered such that they arrive at packet processing platform 106 out of sequence as {P3-B, P2-C, P1-B, P2-B, P3-A, P1-A, P2-A}, that is, out order with respect to the originally-transmitted fragments. While the cause is not specified in the figure, the re-ordering could be the result of different routers and links traversed by different packet fragments, routing policy decisions at one or more packet routers, or other possible actions or circumstances of the network.

As with the example above of out-of-order arrival of integral packets, packet processing platform 106 could be an IPS or other security device, and may require that fragmented packets be reassembled before processing can be carried out. In the exemplary transmission of FIG. 1, packet P3-B must wait for P3-A to arrive before reassembly and subsequent processing can be performed. Similarly, P2-C must wait for P2-B and P2-A, while P1-B must wait for P1-A. In each exemplary instance then, packet processing must be delayed in order to await the arrival of an earlier-sequenced packet. Again, the method and system for controlled delay of packet processing may be advantageously used by packet processing platform 106 to introduce the requisite delay while earlier-arrived, out-of-sequence packets await the arrival of earlier-sequenced packets.

Note that depending upon the particular packet processing carried out, it may or may not be necessary to wait for all fragments of a given packet to arrive before processing begins. For example, it may be sufficient that just pairs of adjacent packet fragments be processed in order. Further, it may not be necessary to actually reassemble packets prior to processing, but only to ensure processing packets or fragments in order. Other particular requirements regarding packet ordering or packet fragment ordering are possible as well. The present invention ensures that delay of packet processing may be introduced in a controlled manner, regardless of the specific details of the processing or the reason(s) for controlled delay.

The examples above present generalized descriptions of the effect on packet processing of the reordering of packets and packet fragments during the course of transmission through a network. In practice, there may be multiple specific circumstances that lead to both fragmentation and reordering of packets within transmissions, and numerous types of communications that may be impacted as a result. A useful example is communication transported between end points using TCP in one or more interconnected IP networks. The following discussion therefore focuses on TCP communications for illustration. However, it should be understood that other types of communication may be subject to fragmentation of packets and reordering of fragments within transmissions, and that the present invention is not limited to TCP-based communications. Further, the description of TCP herein summarizes only certain aspects that are relevant to the present discussion, and omission of any details of the requirements or operation of TCP should not be viewed as limiting with respect to the present invention.

TCP provides a virtual connection between two IP devices for transport and delivery of IP packets via intervening networks, routers, and interconnecting gateways, and is commonly used in IP networks to transport data associated with a variety of applications and application types. TCP also includes mechanisms for segmentation and reassembly of data transmitted in IP packets between the source and destination, as well as for ensuring reliable delivery of transmitted data. For instance, in transmitting a data file from a source to a destination, TCP will segment the file, generate P packets for each segment, assign a sequence number to each IP packet, and communicate control information between each end of the connection to ensure that all segments are properly delivered. At the destination, the sequence numbers will be used to reassemble the original data file.

For communication between two given devices, the TCP Maximum Segment Size (MSS) is generally limited according to the largest packet size, or Maximum Transmission Unit (MTU), used in the underlying host networks of the two devices. Then, the data portion (i.e., payload) of any particular packet transmitted on the established TCP connection will not exceed the MSS. However, the IP packet size at the source may still exceed the MTU of one or more networks or links in the connection path to the destination. When an IP packet arriving, at a router exceeds the MTU of the outbound link, the router must fragment the arriving packet into smaller IP packets prior to forwarding. For instance, an IP packet with TCP segment size 64 kbytes must be fragmented into smaller IP packets in order to traverse an Ethernet link for which the MTU is 1.5 kbytes. The smaller, fragmented IP packets are ultimately delivered to the destination device, where they are reassembled into the original data transmitted from the source. That is, fragmentation introduced by intervening links generally remains all the way to the destination.

As packets and/or packet fragments traverse the connection path, intervening routers (or other forwarding devices) may reorder the initially transmitted sequence. As discussed above, this may occur for a variety of reasons. For instance, a router may queue packets for transmission, preferentially forwarding smaller packets ahead of larger ones. If a given packet stream includes smaller packets that are sequenced later than larger packets, this preferential forwarding may cause smaller packets to arrive at subsequent hops ahead of larger ones, and possibly out of sequence with respect to them. As another example, a router may forward different packets from the same TCP connection on more than one outbound link. Depending on the traffic conditions on each different link and the load on the next-hop router of each of these links, later-sequenced packets and/or packet fragments of a given TCP connection may arrive at the destination (or the next common hop) ahead of earlier-sequenced ones. There may be other causes of out-of-order delivery, as well.

A packet processing platform in the exemplary TCP connection path may thus receive out-of-sequence packets or packet fragments. Without loss of generality, the packet processing platform may be considered to be a network security device, and more particularly an IPS. While this is not required for operation of the present invention, an IPS is exemplary of a device or platform for which the relative order of arriving packets with respect to original transmission sequence can be an important factor. Further, as noted above, while TCP is illustrative of packet data transport that may be subject to packet fragmentation and out-of-sequence delivery of packets, networks and network devices in a transport path may similarly impact other forms of packet transport.

### Controlled Delay of Packet Processing

In carrying out its functions of protecting a network against viruses, Trojan horses, worms, and other sophisticated forms of threats, an IPS effectively monitors every packet bound for the network, subnet, or other devices that it acts to protect. An important aspect of the monitoring is DPI, a detailed inspection of each packet in the context of the communication in which the packet is transmitted. DPI examines the content encapsulated in packet headers and payloads, tracking the state of packet streams between endpoints of a connection. Its actions may be applied to packets of any protocol or transported application type. As successive packets arrive and are examined, coherence of the inspection and tracking may require continuity of packet content from one packet to the next. Thus if a packet arrives out of sequence, inspection may need to be delayed until an earlier-sequenced packet arrives and is inspected. Also, due to the detailed tracking of the packets, the protocol and application using the protocol can be detected, and this information can be used to determine the desired delay for processing a packet.

Another important aspect of IPS operation is speed. While the primary function of an IPS is network protection, the strategy of placing DPI in the packet streams between endpoints necessarily introduces potential delays, as each packet is subject to inspection. Therefore, it is generally a matter of design principle to perform DPI efficiently and rapidly. While the introduction of controlled delay of out-of-sequence packets might appear to compete with the goal of rapid processing, in fact it may help increase efficiency since DPI may execute more smoothly for in-order inspection. Also, by reordering packets the system as a whole may gain performance, due to offloading the reorder task from the end node. However, it is nevertheless desirable to implement controlled delay in such a way as to minimize impact on system resources, and to be able to adjust or select delays for individual packets in a flexible manner and according to dynamic conditions. The discussion below explains in detail how this is accomplished by the present invention.

In certain circumstances of out-of-sequence transmissions, it may be possible to predict the latency period between the arrival of an out-of-sequence packet and the later arrival of the adjacent, in-sequence packet. Such predictions could be based, for instance, on empirical measurements observed at the point of arrival (e.g., an IPS or other packet processing platform), known traffic characteristics of incoming (arriving packet) links, known characteristics of traffic types, retransmission timers, or combinations of these and other factors. A desirable element of controlled delay, then, is to match the delay imposed on a given packet, based on the other related packets carrying the network traffic to a particular destination. By doing so, packet processing that depends on in-order sequencing or the pacing of packets, may be efficiently tuned to properties of the arrivals encountered by packet processing devices.

Controlled Delay of Packet Processing with Single Delay Loop Path with Time Information

U.S. patent application Ser. No. 11/745,307, titled “Method and System for Controlled Delay of Packet Processing with Multiple Loop Paths,” filed on May 7, 2007 by Smith, et al. described an apparatus and method to delay processing packets by sending the packets to be delayed on multiple DLPs, where the packets are removed from each DLP at a specific rate. In Smith, et al., the resulting delay that a packet received is based on the removal rate and the number of packets in the DLP ahead of the packet entering the DLP. That design makes it difficult to delay a packet the desired amount of time when there are many packets being delayed simultaneously. Packets are likely to be delayed a shorter or longer time than is desired when many packets are being delayed and are resident in the DLPs.

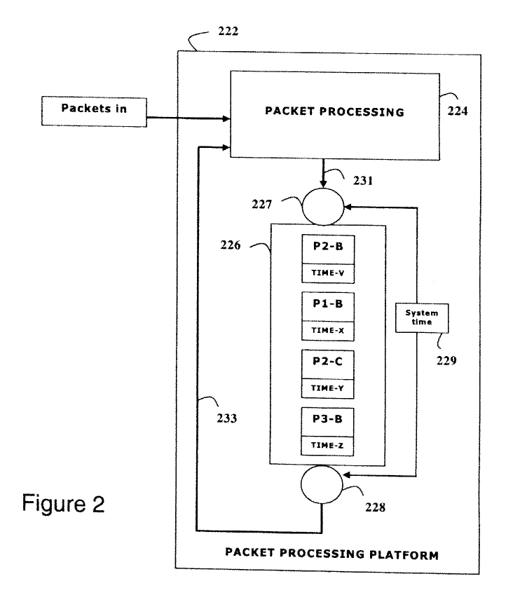

In contrast, the invention provides actual packet processing delays that correspond to a desired delay. As shown in FIG. 2, a time field is added in front of the packet in a FIFO packet store, which is a preferred embodiment of a single DLP within a packet processing platform 222. The embodiment shown includes queue server 228, which uses the time field to only remove packets from the FIFO after a specified delay time, instead of always removing a packet once a time period as disclosed in Smith, et al. Packet fragments P3-B, P2-C, P1-B, and P2-B are shown to have arrived out-of-sequence. As each packet arrives, packet processing 224 determines if a packet need to be delayed and the desired delay value for that packet, then passes the packet with the desired delay value to queue loader 227. The queue loader 227 uses the desired delay value to determine a time value and inserts the time value in the FIFO ahead of the packet. The time value represents the system time when the packet should be removed from the FIFO after waiting the desired delay time. This value is determined by reading system time 229 and adding the desire delay time to the present system time 229 to produce the time when the packet should be removed. This time value will be used by the queue server 228 to know when to remove the associated packet from the FIFO. The system time 229 can be implemented as a time of day clock with millisecond or microsecond resolution or a clocked counter that has a roll over time period at least an order of magnitude larger than the longest desired delay.

Eventually, after the desired delay time has passed, each packet returns to packet processing block 224 via DLP exit 233. Queue server 228 could be invoked via a timer-based interrupt, for instance, which causes the queue server 228 to check if a packet has been added to the FIFO at the head of packet queue 226, and remove a packet if the time value associated with the packet indicates that the desired delay has passed.

According to this embodiment, packet queue 226 is part of the data storage of packet processing platform 222, and can be configured according to a first-in-first-out (FIFO) access discipline. Packet queue server 228 periodically checks the queue to see if a packet has been entered into the queue, and if the queue is not empty, the packet queue server 228 checks the time field to determine if the packet at the head of the queue should be removed. If the packet has not waited the desired delay, the packet queue server 228 posts a timer for a next time the queue should be checked. The packet queue server 228 determines when the packet at the head of the queue should be removed by calculating the difference between the system time and the time value associated with the packet at the head of the queue. The packet queue server 228 will not be invoked until the packet at the head of queue is ready to be removed, because it has been delayed the desired amount of time, and this eliminates unnecessary polling of the queue by the packet queue server 228.

Service time associated with packet queue server 228 can be the time required to copy the packet from queue memory to the input of packet processing platform 224, for instance. Thus the delay that any given packet would experience from the time it enters the queue until it arrives back at packet processing block 224 would be approximately the desired delay time plus the service time associated with the given packet.

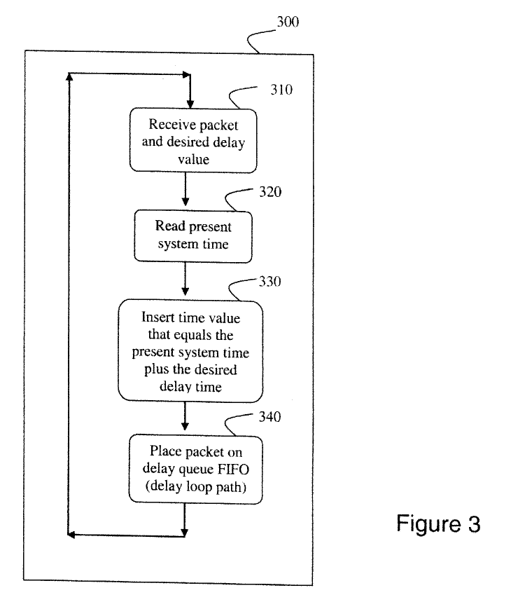

FIG. 3 illustrates the steps taken 300 by the queue loader 227 to insert the time value and the packet in the FIFO. At step 310 a packet and the desired delay time is received that is to be delay. Next the system time is read at step 320. The time value that is be inserted in the FIFO before the packet is the system time when, after a desired delay time period, the packet has been delayed the desire time and should be returned to the packet processing function. This time value is determined by added the desired delay time to the present system time at step 330. At step 340 the time value is transferred into the FIFO followed by the packet to be delayed. These steps are repeated for each packet that has been determined to be delayed by the packet processing function.

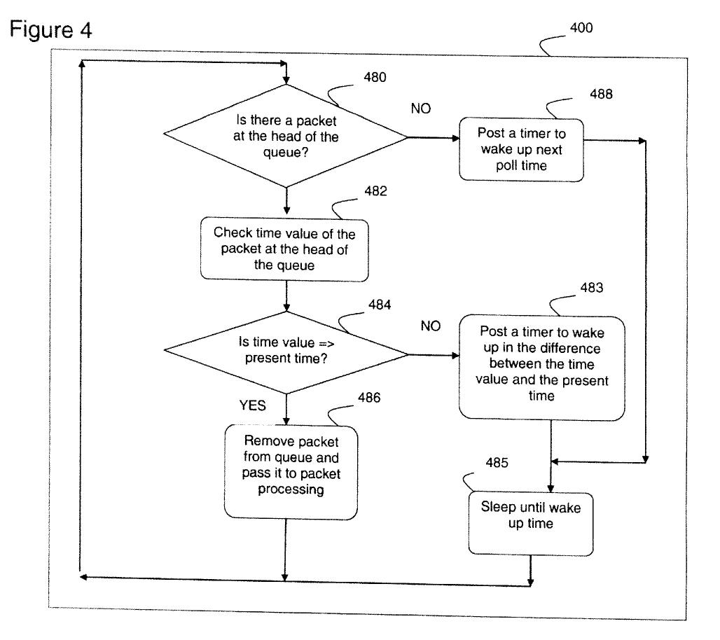

FIG. 4 contains the flow chart that illustrates the steps taken 400 by queue server 228 to check if there is a packet that has been delayed a desired time period and should be sent to the packet processing function. A check is made to determine if there is a packet at the head of the queue at step 480. If there are no packets in the queue, then at step 488 a timer is posted to wake up this process after a poll time has passed. The process will wait at step 485 until the timer wakes up the process. If at step 480 there was a packet found at the head of the queue, then the time value associated with the packet at the head of the queue is read. At step 484, this time value is checked, against the system time to determine if the packet has been delayed the desired delay time and is ready to be returned to the packet process function. If the time value has a time before (greater than) or equal to the present system time, then the packet has been delay long enough and is removed from the queue and passed to the packet processing function at step 486 and then the process will proceed to check the new head of the queue at step 480. If the time value has a time after (less than) the present system time, then the packet has not been delayed the desire delay period, so the period of time left to wait for the packet at the head of the queue is determined by subtracting the time value associated with the packet at the head of the queue from the present system time at step 483. A timer is posted to wakeup the process when the packet at the head of the queue has been delayed the desired time period, this eliminates unnecessary polling of the queue. Once the time has been posted the process waits at step 485. When the process awakes it proceeds to check the queue at step 480.

The embodiment illustrated in FIG. 2 works well when the desired delay is the same for all packets to be delayed. In the examples given earlier the packets where reordered by the network transferring the packet from a source to a destination. Due to packet reordering by the network, a desired delay value of 100 milliseconds for a packet may be found through network traffic studies. Another reason for delaying processing a packet could be due to packet loss and the protocol that transfers this information has a retransmission function, then the desired delay for packets believed to be delayed by packet loss and a retransmission is expected, may be found to be 550 milliseconds. There may also be other reasons for different packet delay values. Due to there being various reasons to delay processing packets, the packet processing function may decide to use multiple delay values. If a packet arrives that has been specified to be delayed by a time period that is shorter than a packet already placed in the queue, then newly arrived packet would have to be put ahead of the packet already waiting in the queue. If the queue used to implement the DLP had an access limitation of only being able to add packet at the tail of the queue and remove packet from the head of the queue, then a single delay queue is not the best implementation. If the queue used to implement the DLP has the ability to insert new packet entries into an ordered list of packets, e.g., a linked list implementation, then a single delay queue could be an efficient implementation. Implementations for inserting packets into an ordered list, such as linked list implementations, are well known. There, the packet is sent to the DLP by inserting the packet in the ordered list of packets. The order of the list of packets can be ordered by the time value associated with the packet on the DLP.

Controlled Delay of Packet Processing with Multiple Delay Loop Paths with Time Information

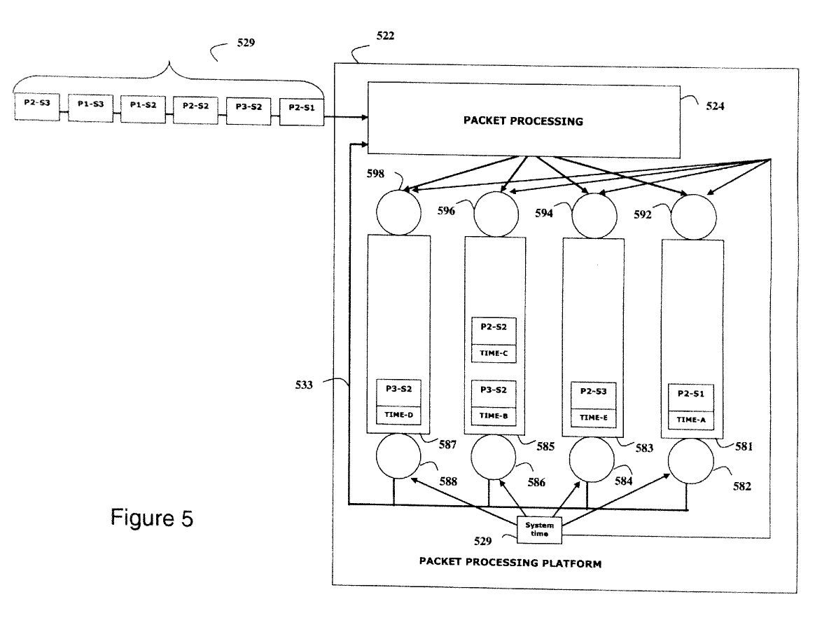

If packets arrive that require varying desired delays and the DLP queue implementation does not provide a insert function in an order list, then multiple delay loop paths provides an implementation option. Multiple queues allow an implementation the ability to group the desired delays into groups varying from short delays to longer delays. If the set of desired delay values are known and this set of desired delay values has fewer elements than the number of available queues to be used as DLPs, then a separate DLP queue may be dedicated to each delay value used. FIG. 5 illustrates an implementation with four DLP FIFO queues 522. There are four different delays used in this example implementation.

The longest delay of 550 milliseconds is used for a protocol that provides retransmission; by network interconnect devices such as a network switch, after 500 milliseconds to deal with lost packets. The delay of 550 milliseconds is used when the packet processing has identified that a packet was received out of order and the out of order condition is assumed to be due to a packet loss. This may be determined by analyzing a packet with an error indication caused the reordering by participating in a link by link protocol with other network interconnect devices, or by observing other protocol indications of packet loss

There is another delay of 300 milliseconds used by the packet processing function to slow down packets from a specific source node or groups of nodes, application, or packets using a specified protocol that has temporarily sent more traffic than is allowed which may degrade overall system performance. This enables the packet processing function to spread out packets that have been bunched up or sent too frequently. By delaying packets that have been identified as consuming more bandwidth than is allowed or is productive, the traffic distribution can be spread out, which keeps the traffic within the allowed or productive rates. If the traffic overload is not due to merely a bunching of packets, that otherwise would be within the allowed rate, but is due to too much traffic sent, the packets will have to be discarded at some point. This delay method is useful when traffic needs to be re-paced.

A third delay value of 100 milliseconds is used when the packet processing function determines the packets have been received out of order, e.g., due to the network reordering the packets, as they passed through the network. The fourth delay of 5 milliseconds is used a catch all for a short delay. This delay can be used as a second chance to delay a packet a little longer before discarding the packet or for other reasons to delay a packet for a short period of time. Since only four delay values will be used by the packet processing function only four DLP FIFO queues are needed. The delay values provided in this example are for illustrative purposes and other implementation may use delay values that are orders of magnitude smaller or larger.

An example is shown in FIG. 5 where packets 529 from three different traffic sessions are received by the packet processing function 524. Four delay values are used and each DLP FIFO is assigned one delay value. DLP 581 has assigned a desired delay value of 550 milliseconds and is used for packets that arrive out of order due to a lost packet and there is packet retransmission provided by the network. DLP 583 has assigned a desired delay value of 300 milliseconds to re-pace traffic that has bunched up. DLP 585 has assigned a desired delay value of 100 milliseconds to delay traffic that has arrived out of order due to the network reordering traffic without packet loss suspected. DLP 587 has assigned a desired delay value of 5 milliseconds used as a last chance delay for packets.

The following scenario is described to illustrate the operation of a preferred embodiment of the invention. The first packet to arrive is packet number 2 of session number 1 P2-S1. The packet processing function 524 determines that packet number 1 of session number 1 was lost and that the network will retransmit packet number 1, so packet P2-S1 is assigned a desired delay of 550 milliseconds and the packet processing function 524 passes the packet and the desired delay to the queue loader 592. The queue loader 592 determines a time value (TIME-A) to place in DPL FIFO 581 before the packet by adding 550 milliseconds to the current system time 529. Then the packet P2-S1 is placed in the DPL FIFO 581, directly following the TIME-A value, by the queue loader 592.

The next packet is packet number 3 of session number 2 P3-S2, the packet processing function 524 determines a desired delay value of 100 milliseconds should be applied to this packet because it has arrived out of order, due to the network reordering the packets. The packet processing function 524 passes the packet P3-S2 and the desired delay to the queue loader 596. The queue loader 596 determines a time value (TIME-B) to place in DPL FIFO 585 before the packet by adding 100 milliseconds to the current system time 529. Then the packet P3-S2 is placed in the DPL FIFO 585, directly following the TIME-B value, by the queue loader 596.

The third packet to arrive is packet number 2 of session number 2 P2-S2 and again the packet processing function 524 determines a desired delay value of 100 milliseconds should be applied to this packet because it has arrived out of order, due to the network reordering the packets. The packet processing function 524 passes the packet P2-S2 and the desired delay to the queue loader 596. The queue loader 596 determines a time value (TIME-C) to place in DPL FIFO 585 before the packet by adding 100 milliseconds to the current system time 529. Then the packet P2-S2 is placed in the DPL FIFO 585, directly following the TIME-C value, by the queue loader 596.

The fourth packet is packet number 1 of session number 2 P1-S2 and the packet processing function 524 again, determines that no delay is needed and processes the packet without delay. The fifth packet is packet number 1 of session number 3 P1-S3 and the packet processing function 524 determines that no delay is needed and processes the packet.

The sixth packet to arrive is packet number 2 of session number 3 P2-S3 and the packet processing function 524 determines that the packets of this session have bunched up and this packet needs to be paced, so a desired delay of 300 milliseconds is selected. The packet processing function 524 passes the packet P2-S3 and the desired delay to the queue loader 594. The queue loader 594 determines a time value (TIME-E) to place in DPL FIFO 583 before the packet by adding 300 milliseconds to the current system time 529. Then the packet P2-S3 is placed in the DPL FIFO 583, directly following the TIME-E value, by the queue loader 594.

After the 100 milliseconds has passed, the packet number 3 of session number 2 P3-S2 is removed from DLP 585 by queue service process 586 and passed back to the packet processing function 524 via path 533. The packet processing function 524 determines further delay is needed so a short desired delay of 10 milliseconds is determined. The packet processing function 524 passes the packet P3-S2 and the desired delay to the queue loader 598. The queue loader 598 determines a time value (TIME-D) to place in DPL FIFO 587 before the packet by adding 10 milliseconds to the current system time 529. Then the packet P3-S2 is placed in the DPL FIFO 587 directly following TIME-D value by the queue loader 598.

Next the queue server function 586 removes packet P2-S2 from DLP FIFO 585 and passes the packet to packet processing function 524 via path 533. The packet processing function 524 can now process this packet. Next the 5 milliseconds passes since packet P3-S2 was placed on DLP FIFO 587 and queue server function 588 removes packet P3-S2 and passes it to the packet processing function 524 via path 533, where the packet is processed. Then packet P2-S3 will be removed from DLP FIFO 583 by queue server function 584 and passed to the packet processing function 524 via path 533. Finally packet P2-S1 will be removed from DLP FIFO 581 by queue server function 582 and passed to the packet processing function 524 via path 533.

Conclusion

An exemplary embodiment of the present invention has been described above. Those skilled in the art will understand, however, that changes and modifications may be made to the embodiment described without departing from the true scope and spirit of the invention, which is defined by the claims.

I claim:

1. A method of introducing controlled delay in the processing of packets in a packet-switched data network, the method comprising:
determining that a packet should be delayed before being processed;
determining a desired delay value for the packet;
associating a time value with the packet based on the desired delay value;
sending the packet on a delay loop path (DLP); and
removing the packet from the DLP when the time value indicates.

2. The method of claim 1, wherein the removing further comprises;
comparing the time value to a system time and;
removing the packet if the time value is a time less than or equal to the system time.

3. The method of claim 1, wherein sending the packet on the DLP comprises inserting the packet in an ordered list of packets.

4. The method of claim 3, wherein the ordered list of packets is ordered by the time value associated with the packet on the DLP.

5. The method of claim 1, wherein sending the packet on the DLP comprises:
adding the packet to a FIFO; and
wherein associating a time value with the packet further comprises:
writing the time value to the FIFO before writing the packet to the FIFO.

6. The method of claim 1, wherein sending the packet on the DLP further comprises:
selecting one of multiple FIFOs;
adding the packet to the selected FIFO; and
wherein the associating a time value with the packet further comprises:
writing the time value to the FIFO before writing the packet to the FIFO.

7. The method of claim 6, wherein the selecting one of multiple FIFOs further comprises:
comparing an assigned delay value for each DLP with the desired delay value of the packet; and
selecting a FIFO having an assigned delay value that is closest in value to the desired delay.

8. The method of claim 1, wherein the determining that the packet should be delayed further comprises:
determining at least one property of the packet.

9. The method of claim 8, wherein determining at least one property of the packet comprises:
inspecting data in the packet; and
determining a relationship of the packet with one or more previously received packets.

10. The method of claim 9, wherein determining the at least one property of the packet further comprises:
determining that the packet is one of a plurality of packets in an ordered sequence and that the packet is out of order with respect to at least one other packet in the ordered sequence.

11. The method of claim 9, wherein determining the at least one property of the packet further comprises:
determining that the packet is one of a plurality of packets in a sequence and that the packet should be delayed to pace the traffic of the packet sequence.

12. A packet processing apparatus with packet delay circuitry comprising:
a first logic unit that determines that a packet should be delayed before the packet is processed or forwarded;
a second logic unit that determines a desired delay value for the packet;
a third logic unit that associates a time value with the packet;
a forth logic unit that sends the packet on a delay loop path (DLPA;
at least one DLP; and
a fifth logic unit that removes the packet from the DLP when the time value indicates.

13. A packet processing apparatus of claim 12, wherein the first, second, third, fourth, and fifth logic units and DLPs are implemented in an FPGA.

14. A packet processing apparatus of claim 12, wherein the first, second, third, fourth, and fifth logic units are implemented in an ASIC.

15. A packet processing apparatus of claim 12, wherein the first, second, third, fourth, and fifth logic units and DLPs are implemented as a combination of hardware and software.

16. A packet processing apparatus of claim 12, wherein the DLP is implemented as an ordered list of packets.

17. A packet processing apparatus of claim 12, wherein one or more DLPs are each implemented as a FFO.

18. A packet processing apparatus of claim 12, wherein the packet processing apparatus is an IPS.

19. A packet processing apparatus of claim 12, wherein the packet processing apparatus connects a public network to a local area network (LAN).

20. A packet processing apparatus of claim 12, wherein the packet processing apparatus is a VPN device.

21. A packet processing apparatus of claim 12, wherein the packet processing apparatus is an Ethernet switch.

22. A packet processing apparatus of claim 12, wherein the packet processing apparatus is a firewall.

23. A packet processing apparatus of claim 12, wherein the packet processing apparatus is an intelligent network adapter.
